(19) United States
(12) Patent Application Publication
(10) Pub. No.: US 2017/0169049 A1
(43) Pub. Date: Jun. 15, 2017

(54) Staging Log-Based Page Blobs on a Filesystem

(71) Applicant: Microsoft Technology Licensing, LLC, Redmond, WA (US)

(72) Inventors: Qibo Zhu, Sammamish, WA (US); Ali Ediz Turkoglu, Sammamish, WA (US); Michael Christopher Johnson, Bothell, WA (US)

(21) Appl. No.: 15/071,008

(22) Filed: Mar. 15, 2016

Related U.S. Application Data
(60) Provisional application No. 62/267,799, filed on Dec. 15, 2015.

(51) Int. Cl. G06F 17/30

(52) U.S. Cl. CPC G06F 17/30174; G06F 17/30165; G06F 17/3023

(57) ABSTRACT

One embodiment illustrated herein includes a method that may be practiced in a computing environment. The method includes acts for atomically writing data up to a predetermined maximum size of data to a blob object, wherein a blob object comprises a combination of a backing file in a traditional file system and a database record in a traditional database. The method includes writing data to one or more shared staging files. The method further includes cloning associated extents from the one or more shared staging files to a destination file representing the blob object at a desired offset desired by a client.

### CROSS-REFERENCE TO RELATED APPLICATIONS

This application claims the benefit of and priority to U.S. Provisional Patent Application Ser. No. 62/267799 filed on Dec. 15, 2015 and entitled “Staging Log-Based Page Blobs on a Filesystem,” which application is expressly incorporated herein by reference in its entirety.

### BACKGROUND

### Background and Relevant Art

Computers and computing systems have affected nearly every aspect of modern living. Computers are generally involved in work, recreation, healthcare, transportation, entertainment, household management, etc.

Computing systems often implement functionality related to data manipulation and storage. For example, data may be stored in files stored in filesystems. Alternatively, data may be stored in a database, such as in database tables and the like. Sometimes, the concepts of file storage and database storage may be combined. For example, a blob (Binary Large Object) includes a combination of a backing file in a traditional file system and a database record in a traditional database. Blob objects may be particularly useful for storing large files (such as images, audio, multimedia, or other objects) as objects in a database.

In databases, it is often useful to perform transactional computing. In transactional computing, either all operations in a set of operations are performed, or none of the operations in the set of operations are performed. Thus, for example, if a set of database operations were configured to debit one account a given amount and credit a different account the given amount, it could be disastrous if either only the debit or credit were performed. Thus, transactional computing would ensure that both the debit and credit were performed or that the neither the debit nor the credit is performed.

Because of the comparatively large nature of blob objects, and the comparatively smaller limits on file size for transactional computing in file systems, transactional computing can be difficult when working with blob objects.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a computing environment. The method includes acts for atomically writing data up to a predetermined maximum size of data to a blob object, wherein a blob object comprises a combination of a backing file in a traditional file system and a database record in a traditional database. The method includes writing data to one or more shared staging files. The method further includes cloning associated extents from the one or more shared staging files to a destination file representing the blob object at a desired offset desired by a client.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a blob service frontend interacting with a blob service backend;

FIG. 2A illustrates the addition of cluster alignment fillers for write buffers;

FIG. 2B illustrates an example of adding a write buffer to a shared stating file and adding the write buffer to a page blob file by duplicating extents; and

FIG. 3 illustrates a method of atomically writing data up to a predetermined maximum size of data to a blob object.

### DETAILED DESCRIPTION

Embodiments may implement a system for atomically (i.e., all operations in a set of operations are performed or all operations in the set of operations are not performed) writing data up to a predetermined maximum size of data (e.g., up to 4 MB or some other selected size) to a blob object. A blob object comprises a combination of a backing file in a traditional file system and a database record in a traditional database. Blob objects may be particularly useful for storing large objects (such as images, audio, multimedia, or other objects) in a database.

Embodiments may implement transactional writes by writing data to one or more shared staging files. The system then clones associated extents from the one or more shared staging files to a destination file representing the blob object at a desired offset desired by a client to accomplish the transactional write.

In particular, embodiments can realize random read/write access and atomicity semantics via a staging log and tight integration into file system capabilities such as extent cloning. Extent cloning (sometimes referred to as extent duplication) is an operation that clones (“duplicates”) a range of blocks from one file into another range of the same file or a different file. As used herein, an “extent” is a single contiguous sequence of blocks, starting at a specific offset of a store. A “block” frequently refers to the smallest unit of write to a storage system, and is often the atomic write size. Note however, this is typically determined by the underlying storage media, although sometimes the file system can modify that value.

Embodiments can implement atomic and resilient random read/write access to page blob objects, such as those used in Windows Azure available from Microsoft Corporation of Redmond, Wash., exposed by a distributed system, using “shared” or “dedicated” staging files for each frontend message processor of a distributed system, and using file system capabilities like “extent cloning”.

Additional details are now illustrated.

In general, underlying storage systems have atomic write sizes which are relatively small, such as, for example, 512 bytes for certain hard disk drive technologies. Typically, the atomic write sizes for a storage system are specific to a given storage system. The unit size of an extent duplication, in some systems, such as Resilient File System (ReFS), available from Microsoft Corporation of Redmond Washington, is based on cluster size presented by the file system and so is not directly related to the atomic write size for the storage medium. Thus, atomic write size for a data write is typically determined by the underlying storage medium. The unit of extent duplication is typically determined by the cluster size selected by the file system. In many file systems, individual files are comprised of a set of sequentially arranged clusters.

In some embodiments, the file system function which duplicates an extent from a source file into a target file is constrained to work only on pieces of the file which are both aligned to a multiple of a single cluster and have a length of a multiple of the cluster. That is, the extent to be duplicated both starts and ends on a cluster boundary.

The file system operation to duplicate an extent from a source file a target file is an atomic operation. There may be a limit to the number of clusters which are present in the extent to be duplicated which allow the duplication operation to remain atomic. In the case of ReFS (Redundant File System available from Microsoft Corporation of Redmond, Wash.) limits may be due to an internal logging mechanism. For example, in order to record the change in the set of blocks mapped to a file, the file system records the change in an internal data structure written from memory to disk. For the high level clone operation to be atomic, all of the changes required to perform that atomic operation are recorded in an atomic operation within the file system. Thus, if there is an internal atomicity limit in the file system, that is reflected in the limit presented by the high level operation. For example, in some embodiments using ReFS the limitation on an atomic extent cloning operation is of the order 1 Gigabyte. This value limitation is file system dependent and could easily change from one version of the file system to the next.

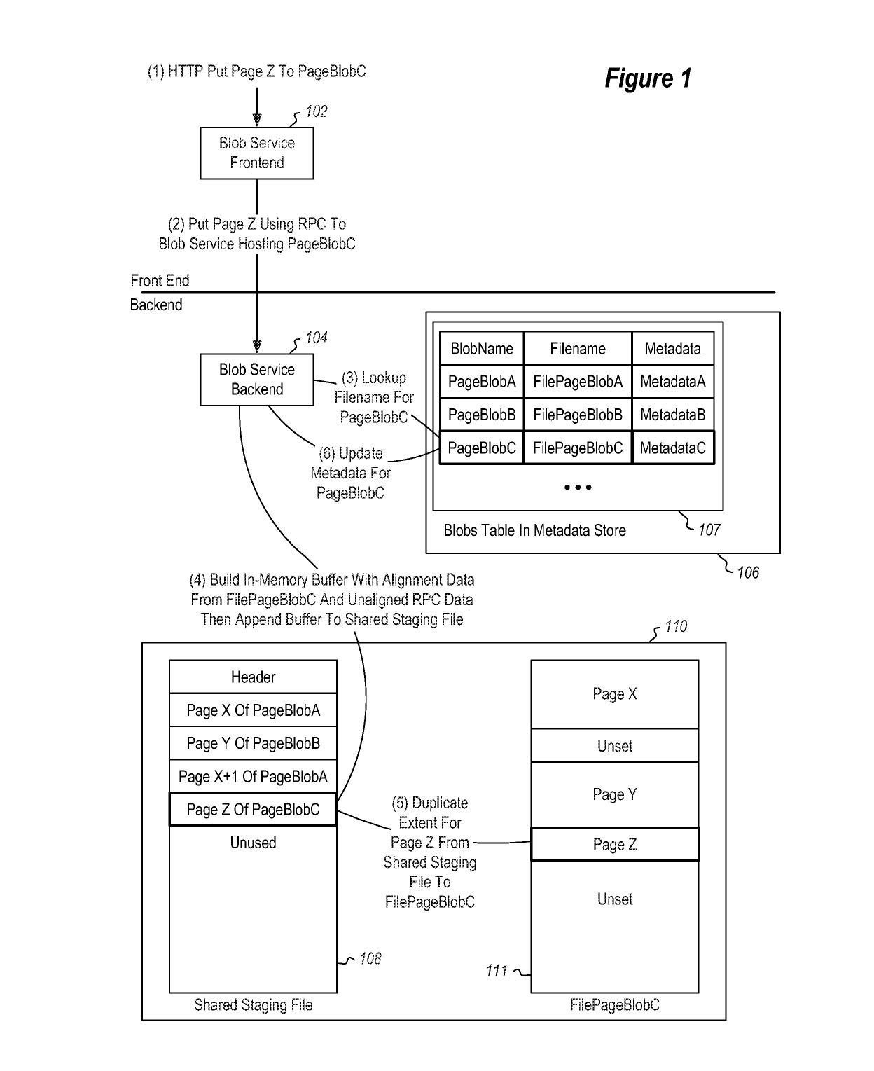

Referring now to FIG. 1, an example is illustrated. FIG. 1 illustrates a blob service frontend 102. The blob service frontend 102, may be for example, a web service accessible by a user such that the user can request various data operations. While a single blob service frontend 102 is illustrated, it should be appreciated that multiple blob service frontends can be implemented within the scope of embodiments of the invention.

As illustrated at (1), an external client sends an HTTP request to the blob service frontend 102 invoking a PutPage API which identifies the target page blob by name, the offset within the page blob, and a buffer full of data to be inserted into the page blob. The amount of data is arbitrary and in particular can be significantly larger than the atomic write size of the underlying storage system. In some embodiments, there are some limitations of the PutPage. API such as: a maximum data buffer size of 4 MB; offsets needing to be a multiple of 512; etc. However, these may simply be implementation choices and other embodiments may not have these limitations.

The blob service frontend 102 is coupled to one or more blob service backends, such as the blob service backend 104. The blob service backend 104 communicates with various filesystem components and database components to implement blob storage and manipulation. As illustrated at (2) in FIG. 1, in the illustrated example, the blob service frontend 102 selects an appropriate blob service backend 104 and sends a PutPage request as an Remote Procedure Call (RPC) message. In this example, this includes the name of the blob, the data to be inserted into the blob and the offset at which the insertion should take place.

The blob service backend 104 is coupled to a metadata store 106, which may be, for example, a database storage system. As illustrated at (3), the blob service backend 104 queries a blobs table 107 from the metadata store 106 using the blob name to retrieve the metadata record for the blob. In particular the name of the file being used to represent the page blob is retrieved.

In the illustrated example, the blob service backend 104 is also coupled to a shared staging file 108. As illustrated at (4), once the page blob file name is retrieved, the parameters from the PutPage request, including the supplied data are used to construct an in-memory buffer. If the PutPage operation is to insert data at an offset which is not a multiple of the cluster size for the file system, then, in some embodiments, a filler piece is read from the target file to ensure that the buffer containing the data to be inserted in the page blob is aligned on a cluster boundary. The same procedure may be implemented for the end of the buffer.

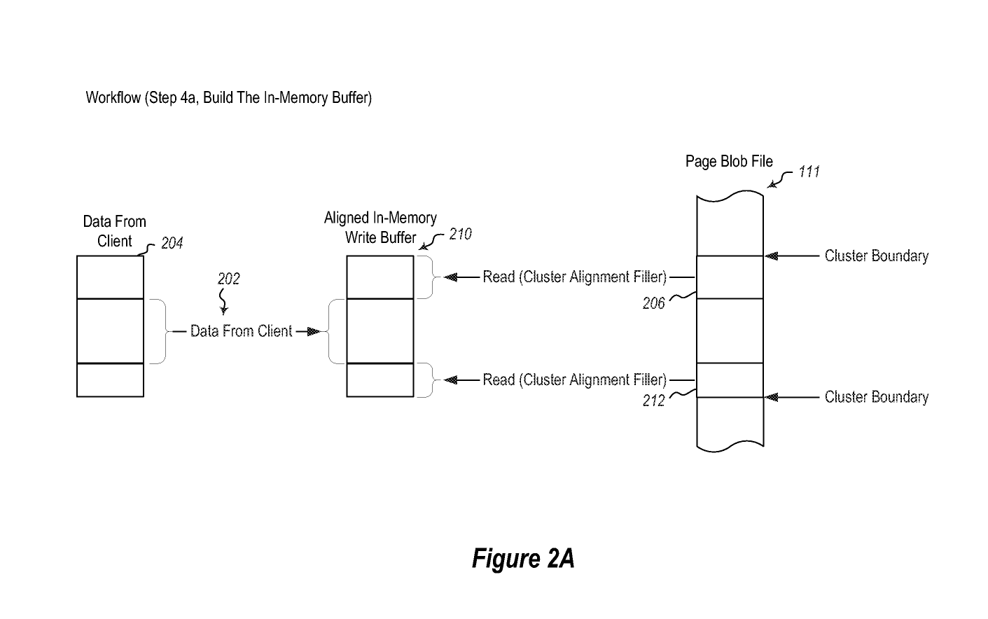

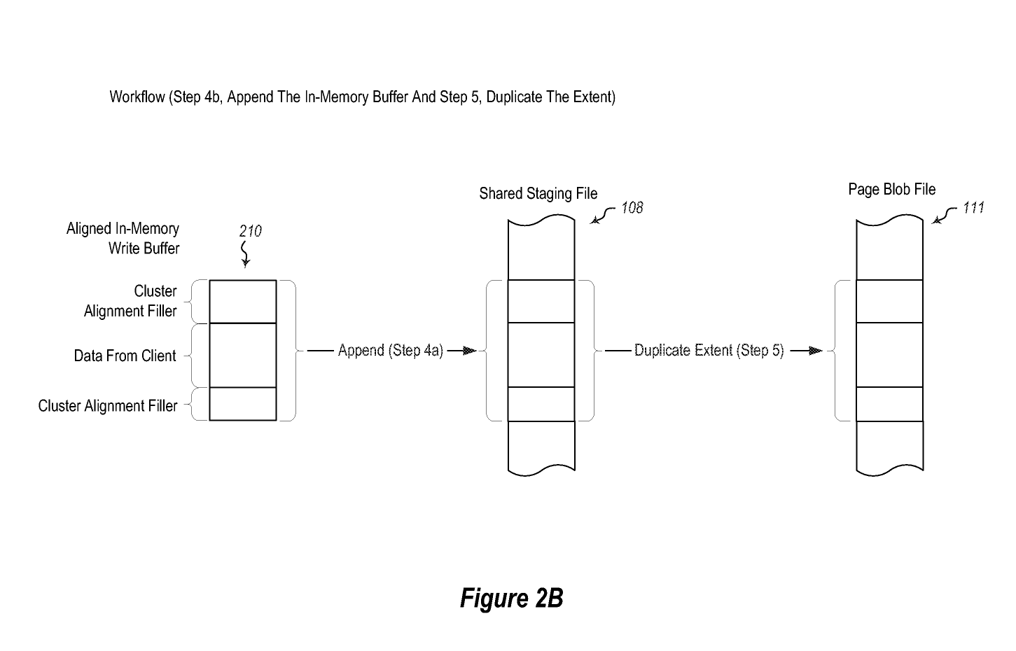

For example, FIG. 2A illustrates at 202 that data 204 is received from a client. If the data received from the client is not a multiple of the cluster size for the file system, then a cluster alignment filler 206 is read from a target page blob file 111 and prepended to a write buffer 210. FIG. 2A also illustrates that another cluster alignment filler 212 is read from the target page blob file 111 and appended to the end of the write buffer 210. This allows the write buffer 210 to be aligned in memory.

Once the buffer is completely built with any needed filler prefix, the data to be inserted, and needed filler postfix, it is appended to the shared staging file 108, on the next available cluster boundary. Adding the prefix and/or postfix filler pieces is used if there is a mismatch between the cluster size of the file system hosting the file representing the page blob and the offset and length alignment limitations of the PutPage API, such that the PutPage API limitations are smaller than those of the file system. For example, if the file system cluster size is 512 bytes, and the PutPage API requires that both offset and length of the data to be inserted be aligned to a 512 byte boundary, then no filler pieces are used.

If the tile system cluster size is 512 bytes, and the PutPage API requires that both offset and length of the data to be inserted be aligned to a 1024 byte boundary, then no filler pieces are used as the smallest PutPage API request can be described in terms of a multiple of the cluster boundary.

If the file system cluster size is 4096 bytes, and the PutPage API requires that both offset and length of the data to be inserted be aligned to a 512 byte boundary, then filler pieces can be used for any request where the offset and/or length are not aligned to a file system cluster boundary.

FIG. 2B illustrates an example of adding the write buffer 210 to a shared staging file 108. Additionally, the write buffer 210 is added to a page blob file 111 by duplicating extents.

Illustratively, and returning once again to FIG. 1, and as illustrated at (5), once the appending write to the shared staging file 108 has completed, the blob service backend calls a file system 110 to duplicate the extent in the shared staging file 108 that contains the data (along with any required filler pieces) to insert it into a page blob file 111 in the file system representing the page blob. This completely replaces the extent in the page blob file 111. As illustrated at (6), once the file system has completed the extent duplication operation, the blob service backend 104 updates the record in the blobs table 107 in the metadata store 106 for the page blob. For example, “MetadataC” is modified and written back to the table 107 in the metadata store 106. Examples of changes might include a “last modified time” and “last applied transaction ID”.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

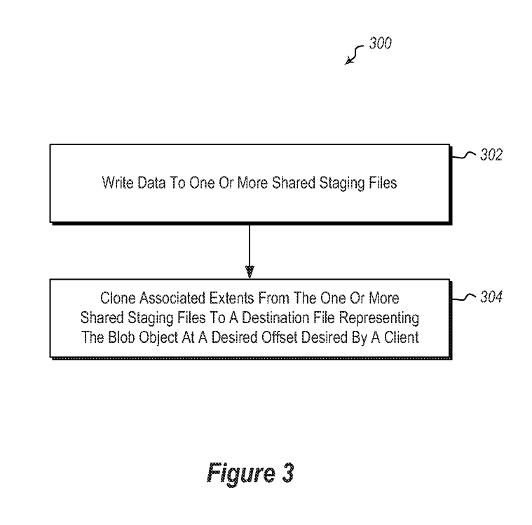

Referring now to FIG. 3, a method 300 is illustrated. The method 300 may be practiced in a computing environment and includes acts for atomically writing data up to a predetermined maximum (e.g., up to 4 MB) size of data to a blob object. A blob object includes a combination of a hacking file in a traditional file system and a database record in a traditional database. The method 300 includes writing data to one or more shared staging files (act 302). For example, as illustrated above, data may be written to the shared staging file 108.

The method 300 further includes cloning associated extents from the one or more shared staging files to a destination file representing the blob object at a desired offset desired by a client (act 304). For example, as illustrated in FIG. 1, the extents from the shared staging file 108 are cloned in the page blob file 111.

The method 300 may be practiced where writing data to one or more shared staging files is performed in an append-only manner. Thus, as illustrated in FIG. 1, data is appended onto the end of other existing data in the shared staging file 108. In some embodiments, writing data to one or more shared staging files in an append-only manner allows multiple s to be performed together with different offsets (e.g., from different frontend entities, such as different blob service frontends 102).

The method 300 may further include updating a database record for the object. For example, as illustrated above, embodiments may update the blobs table 107 in the metadata store 106. In some embodiments, this may include updating a last modified time of the object and a last applied transaction ID for the object. Transacton IDs are generated at the time an in-memory data buffer is appended to the staging file, such that each appending write is assigned an increasing, unique value or “Transaction Id” which is appended to the staging tile along with other control information as part of the in-memory buffer. The transaction ID is an identifier associated with a specific appended write, or PutPage call. Updating a last modified time of the object and a last applied transaction ID for the object allows embodiments to repair data in the event of a crash or other error. For example, the method 300 may further include, at a crash, replaying the staging file. Replaying the staging file may include skipping records for which a transaction id has already been applied (i.e., in certain embodiments, all transaction IDs that are smaller than the last applied transaction ID in the database record).

Embodiments may be practiced where the operations that clone the extent and update the transaction ID are transactional (i.e., atomic).

The method 300 may be performed by one or more frontends writing to the shared staging file directly and then communicating with a backend (e.g., a blob service) directing the backend to commit the data write. For example, as illustrated in FIG. 1, a blob service frontend 102 (or a plurality of different blob service frontends) could write directly to the shared staging file 108 and then cause the blob service backend 104 to commit the data write to page blob tile 111 by cloning the extents and updating metadata in the blobs table 107.

Alternatively or additionally, the method 300 may be performed by one or more frontends transferring the data to a backend then communicating with the back end (e.g., a blob service) directing the backend to write the data and commit the data write. For example, as illustrated in FIG. 1, the blob service frontend 102 may transfer data to the blob service backend 104. The blob service backend 104 can then manage writing data to the shared staging file 108, cloning extents for the page blob file 111, and updating metadata in the blobs table 107.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part,by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
one or more processors; and
one or more computer-readable media having stored thereon instructions that are executable by the one or more processors to configure the computer system to atomically write data up to a predetermined maximum size of data to a blob object, including instructions that are executable to configure the computer system to perform at least the following:
writing data to one or ore shared staging files; and
cloning associated extents from the one or more shared staging files to a destination file representing the blob object at a desired offset desired by a client.

2. The system of claim 1, wherein the one or more computer-readable media have stored thereon instructions that are executable by the one or more processors to configure the computer system to write data to one or more shared staging files in an append-only manner.

3. The system of claim 2, wherein the one or more computer-readable media have stored thereon instructions that are executable by the one or more processors to configure the computer system to write data to one or more shared staging files in an append-only manner as part of operations to perform multiple writes together with different offsets.

4. The system of claim 1, further wherein the one or more computer-readable media have stored thereon instructions that are executable by the one or more processors to configure the computer system to update a database record for the object.

5. The system of claim 4, further wherein the one or more computer-readable media have stored thereon instructions that are executable by the one or more processors to configure the computer system to update last modified time of the object and a last applied transaction ID for the object.

6. The system of claim 5, further wherein the one or more computer-readable media have stored thereon instructions that are executable by the one or more processors to configure the computer system to, at a crash, replay the staging file, wherein replaying the staging file comprising skipping records for which a transaction id has already been applied.

7. The system of claim 5, wherein the one or more computer-readable media have stored thereon instructions that are executable by the one or more processors to configure the computer system to perform operations that clone the extent and update the transaction ID transactionally.

8. The system of claim 1, wherein the one or more computer-readable media have stored thereon instructions that are executable by the one or more processors to configure the computer system to cause one or more frontends to write to the shared staging file directly and then communicating with a backend directing the backend to commit the data write.

9. The system of claim 1, wherein the one or more computer-readable media have stored thereon instructions that are executable by the one or more processors to configure the computer system to cause one or more frontends to transfer the data to a backend and then communicate with the backend directing the backend to write the data and commit the data write.

10. In a computing environment, a method of atomically writing data up to a predetermined maximum size of data to a blob object, wherein a blob object comprises a combination of a backing file in a traditional file system and a database record in a traditional database, the method comprising:
writing data to one or more shared staging files; and
cloning associated extents from the one or more shared staging files to a destination file representing the blob object at a desired offset desired by a client.

11. The method of claim 10, wherein writing data to one or more shared staging files is performed in an append-only manner.

12. The method of claim 11, wherein writing data to one or more shared staging files in an append-only manner is performed as part of operations to perform multiple writes together with different offsets.

13. The method of claim 10, further comprising updating a database record for the object.

14. The method of claim 13, farther comprising updating a last modified time of the object and a last applied transaction ID for the object.

15. The method of claim 14, further comprising, at a crash, replaying the staging file, wherein replaying the staging file comprising skipping records for which a transaction id has already been applied.

16. The method of claim 14, wherein the operations that clone the extent and update the transaction ID are transactional.

17. The method of claim 10, wherein the method is performed by one or more frontends writing to the shared staging tile directly and then communicating with a backend directing the backend to commit the data write.

18. The method of claim 10, wherein the method is performed by one or more frontends transferring the data to a backend then communicating with the backend directing the backend to write the data and commit the data write.

19. A system comprising:
a blob service backend configured to atomically write data up to a predetermined maximum size of data to a blob object, including:
writing data to one or more shared staging files; and
cloning associated extents from the one or more shared staging files to a destination file representing the blob object at a desired offset desired by a client.

20. The system of claim 19, wherein the blob service backend is configured to receive the data from a blob service frontend.
